(19) United States
(12) Patent Application Publication
(10) Pub. No.: US 2023/0325711 A1
(43) Pub. Date: Oct. 12, 2023

(54) METHODS AND SYSTEMS FOR UPDATING MACHINE LEARNING MODELS

(71) Applicant: Telefonaktiebolaget LM Ericsson (publ), Stockholm (SE)

(72) Inventors: Johan HARALDSON, Stockholm (SE); Ezeddin AL HAKIM, London (GB); Henrik ERIKSSON, Enskede (SE); Yeongwoo KIM, Kista (SE)

(73) Assignee: Telefonaktiebolaget LM Ericsson (publ), Stockholm (SE)

(21) Appl. No.: 18/027,061

(22) PCT Filed: Sep. 18, 2020
(86) PCT No.: PCT/SE2020/050872

§ 371 Date: Mar. 17, 2023

(51) Int. Cl. G06N 20/00

(52) U.S. Cl. CPC G06N 20/00

(57) ABSTRACT

Methods (1100) and systems (800) for updating ML models. The method is performed by a client computing device (704(1)). In one aspect, the method comprises obtaining (s1102) a first machine learning (ML) model. The first ML model is configured to receive input data set and to generate first output data set. The method further comprises training (s1104) a second ML model 5 based at least on the input data set and the first output data set, obtaining (s1106), as a result of training the second ML model, a third ML model, and deploying the third ML model.

### TECHNICAL FIELD

Disclosed are embodiments related to methods and systems for updating machine learning (ML) models.

### BACKGROUND

Today there is a massive growth of mobile network traffic, which leads to an increased total energy consumption of mobile network(s). To meet the massive traffic growth challenge and lower the total energy consumption of the mobile network(s), a holistic solution is provided (e.g., as described in [6]).

This holistic solution is made up of four elements: (1) modernizing the existing network, (2) activating energy saving software, (3) building 5G network system with precision, and (4) operating site infrastructure intelligently. Each of these four elements may contribute to achieving the goal of meeting the massive traffic growth challenge and/or lowering the total energy consumption of the mobile network(s).

An exemplary effect of one of the elements of the holistic solution is illustrated in FIG. 1. As shown in FIG. 1, as mobile communication technology improves, energy consumption of mobile network(s) increases. But, by modernizing the existing network, it is possible to lower the energy consumption of the mobile network(s).

FIG. 2 shows a typical traffic distribution across sites in a network. This traffic distribution has shown to be true for 2G, 3G, and 4G. Traffic growth follows the same curve, with greater growth in sites with high traffic load and lower growth in sites with low traffic load. Typically, the focus has been on the most valuable sites (corresponding to segments 202 and 204), increasing spectrum efficiency and expanding capacity to meet the demand. Segment 206, however, can be selected as a target segment for energy savings through modernization. Using the latest Ericsson™ Radio System (ERS) equipment, it is possible to immediately lower energy consumption by 30%.

A common misunderstanding of FIG. 2 is to assume that sites with high load are located in the urban areas and sites with low load are located in the rural areas (e.g., as described in [8]). But as illustrated in FIG. 3, sites with high and low load exist in all environments (e.g., as described in [6]).

When introducing 5G, one of the key elements in the above described holistic solution is to build the network system with precision. This means that service providers of wireless communication networks need to match the technical capacity of a site with the forecasted traffic growth of that site.

Another element of the holistic solution is to activate energy-saving software functionality that automatically switches equipments on and off to follow traffic demand as the traffic demand varies over time. The lowest possible energy consumption while maintaining network performance may be achieved through advanced measurements predicting (1) traffic patterns, (2) load, and (3) end-user needs, from cell to subframe levels. FIG. 4 shows daily pattern of traffic load. In FIG. 4, the highlighted part shows the gaps in data packet transmission during a high-traffic situation. As shown in FIG. 4, it is not only possible to switch on and off equipment(s) in low traffic load, but also in high traffic load on a sub-second level.

Examples of 4G and 5G energy saving features are as follows: In the Ericsson™ technology roadmap, Micro Sleep Tx (MSTx), Low Energy Scheduler Solution (LESS), MIMO Sleep Mode (MSM), Cell Sleep Mode (CSM), and Massive MIMO Sleep Mode are provided. In 4G, MSTx and LESS can reduce the energy consumption of radio equipment(s) up to 15%. Trials with MSM has shown an average of 14% savings per site when using Machine Learning (ML) to set the optimal thresholds. In 5G, the energy consumption savings will increase further due to the 5G radio interface enabling longer sleep periods for the power amplifiers, as illustrated in FIG. 5. FIG. 5 shows exemplary energy consumptions of a base station during idle mode signaling in LTE (top) and NR (bottom). Important to note is that all savings may be achieved while maintaining network Key Performance Indicators (KPIs) and user experience (e.g., as described in [1], [6], and [7]).

The last element of the holistic solution is to operate site infrastructure more intelligently. The rationale of this approach—operating site infrastructure more intelligently—is that passive elements (e.g., battery, diesel generator, rectifier, HVAC, solar, etc.) supporting the Radio Access Network (RAN) represent over 50% of the overall site power consumption. The Ericsson™ Smart Connected Site enables all site elements to be visible, measurable, and controllable to enable remote and intelligent site management. Customer cases have shown reduced site energy consumption by up to 15% through intelligent site control solutions, powered by automation and Artificial Intelligence (AI) technologies.

To successfully execute the above described solutions, operation(s), administration and maintenance (OAM) of the above-mentioned elements is critical. The OAM may be performed by network managers (e.g., the Ericsson™ Network Manager (ENM)). The ENM enables accessing to data from the sites and allows other solutions (e.g., Ericsson™ Network IQ Statistics (ENIQ Statistics) and Ericsson™ Energy Report) to consume/use the data.

The reference [6] provides the following summary of key insights:

Energy savings may be applied to all sites, not just the sites carrying the most traffic. It may be desirable to consider traffic demand and growth of every site individually.

Equipment can be switched on and off on different time scales, ranging from micro-seconds to minutes. Energy-saving software contributes substantially to lowering energy consumption. By its inherent design, 5G enables further savings of energy consumption. Predictive elements and Machine Learning (ML) are key enablers of energy-saving software.

Intelligent solutions are enabled by a central data collection from all site elements and the use of ML and Artificial Intelligence (AI) technologies.

From a ML perspective, the proposed solution described in the reference [6] has several challenges. Some of the challenges are explained below.

Data Collection

The proposed solution requires data to be sent over a network from all sites to a central server where individual considerations can be made for each site. This procedure is used today to collect Performance Management (PM) counters with a Recording Output Period (ROP) of 15 minutes. Lowering the ROP time to 1 second would increase the data transfer by two orders of magnitude. The present energy-saving features operate on a time scale ranging from micro-seconds to minutes. The central solution, however, may not scalable to support these features.

Model Management

(1) Scalable Predictions—ML is proposed as a key enabler of energy-saving software. Prediction of demands and growths of network traffic is most commonly made using statistical forecast methods (Autoregressive Integrated Moving Average (ARIMA), Holt-Winters, etc.). A limitation of these methods is that they often require an expert to model each time series. In a scenario where thousands or millions of time series need to be modeled in parallel, this approach is not scalable. A promising alternative to the statistical forecast methods is using neural networks (e.g., as described in [9]), which allows to model complex behaviors, leverage hardware acceleration, and distribute the training and inference.

(2) Site Heterogeneity and Need for Multiple Models—The reference [6] highlights a customer trial where a ML model was trained to find the optimal thresholds of the energy-saving feature (e.g., MIMO Sleep Mode) for a cluster of 6 sites, which represents a mix of rural and urban locations. To scale the solution beyond the trial it is necessary to train the model using data from either all sites or a sample of sites, and continuously monitor and update the model over time as traffic demands and growth patterns change.

Due to the heterogeneous nature of the mobile network with various different configurations, geographical locations, various user behavior, however, a single model may not be an appropriate fit for all sites. The standard solution to this problem is to collect more data and introduce more features. Another solution is to group sites having similar patterns and train one ML model per each group.

To calculate data similarity between sites, it is necessary to collect configuration data and training data from all sites. Furthermore, these processes of collecting and training need to be performed continuously as traffic demand and growth would change as time goes by. The central-location-based approach (e.g., collecting data and performing a model training at the central location) is neither scalable nor suitable for these needs.

(3) Continuous Learning—Looking at network resource demand across longer time periods, it is noticeable that the demand shows at least three seasonal patterns: daily, monthly, and yearly. Due to storage limitations of base stations, however, it is not possible to store large amounts of data, thereby limiting the possibility to store, for example, data covering all seasons, which is necessary for an ML model to learn the seasonal patterns.

In addition, there may be events that would impact the demand. For example, the events include public events, city infrastructure projects, modifications to the mobile network install base, etc. In continuous optimizing of model performance metrics, this dynamic nature of traffic demand requires the system to perform continuous learning, to adapt to changes of season, configuration, and environment, to allow groups to dynamically add and/or remove sites, and/or to allow new groups to be formed and/or other groups to be removed.

Latency and Load

A centralized solution for ML (e.g., collecting data and/or training a model based on the collected data, at a central system) is attractive since many wireless communication networks already have data collection mechanisms in place. In addition to the scalability issues of data collection, continuous training, and/or updating of ML models, however, the centralized solution may also suffer interference issue.

Different energy-saving features take decisions at different time intervals. Thus, for those energy-saving features that take decisions at a short time interval, in order to make predictions, data needed for running the ML model needs to reside at the same location as the ML model. Increasing the time interval may allow the ML model to reside at the central location as long as the central location is closer to the site where the data needed for the ML model resides. For example, for energy-saving features that operate on micro or milli-second level, the ML model would need to reside within the site that is close to where the data is stored.

But even if the latency requirement of the decision can be satisfied, there may be an issue of increased loads on the backhaul links. Because of these potential increased loads on the backhaul links, the central solution may not be scalable.

Privacy

If the data needed for training the ML model resides within one operator network in a specific region, it can be possible to collect the data in the central location. Many network operators (e.g., Vodafone, Orange, Telefonica, etc.), however, operate across several regions, and the data cannot be shared easily between the regions. Also, for a service (e.g., Ericsson™'s Business Areas Managed Services (BMAS)) that operates on several customer (e.g., network operators) networks, it is essential to not mix the data from the different network operators. To allow joint learning between different operators and/or different regions, it is necessary to introduce privacy-preserving learning methods. One of the methods is Federated Learning (FL).

### SUMMARY

### 1. Federated Learning (FL)

One way of solving the privacy issue of the central solution is a FL—a decentralized ML (e.g., as described in [5]). The main idea of the FL is that devices in a network collaboratively learn and/or train a shared prediction model without the training data ever leaving the devices. The use of FL is motivated by many factors including limitations in uplink bandwidth, limitations in network coverage, and restrictions in transferring privacy sensitive data over network(s). Performing ML trainings at devices (e.g., base stations) rather than at the central entity (e.g., a central network node) is enabled due to increased computation capability and hardware acceleration available at the devices.

FL may involve a server and multiple client computing devices (herein after “clients”). In the beginning, the server initializes a global model W_{G} and send it to the clients (as shown in FIG. 6). After receiving the global model W_{G} at each client, a local model W_{L} for each client is initialized as the global model (i.e., W_{L}=W_{G}). Then, the local model at each client is trained and updated using the local data available at each client. The trained and updated local models are then transmitted to the server, and the server updates the global model by combining (e.g., averaging or weighted-averaging) the received local models (e.g., as shown in FIG. 6). By repeating the process of training the local model at each client and combining (e.g., averaging) the trained local models at the server, it is possible to build a sophisticated global model W_{G}.

By performing the ML training at each client and building an optimized global model at the server, the FL solves the problems discussed above. For example, in FL, since data is not transferred to a central server, the need for massive storage and high bandwidth between a site and a server is reduced. Also, in FL, since the ML model and the data needed for training the ML model are located at the same location (i.e., the same client), it is possible to reduce latency, preserve privacy, and perform continuous model evaluation without the need to transfer the data to the central location (e.g., the central network node).

On the other hand, there are still remaining challenges regarding continuous updates of a ML mode. For example, since data is generated and stored in a site, due to the storage limitations at the site, it may be difficult to store enough data to capture, for example, seasonal changes and/or event specific patterns that are necessary to predict, for example, traffic demand and growth. There is no known mechanism for continuously making updates to the model, incorporating knowledge that is no longer represented in the data stored in the clients.

### 2. Transfer Learning

Transfer learning (e.g., as described in [2]) is one of the techniques in ML which utilizes knowledge from a model and applies the knowledge to another related problem.

2.1. Parameter Transfer

When a model is trained by a dataset, the model holds knowledge of a task. Because the knowledge is accumulated in weights of the trained model, it is possible to apply the knowledge to a new model in order to initialize the new model or fix the weights of a part of the new model. In case the weights of a pre-trained model are fixed, the backpropagation only updates new layers in the new model.

On the other hand, when the model is trained by transfer learning, the model can be trained using less training data as compared to the conventional training in which a model is trained using random initialization. Hence, through the transfer learning, high performance of the new model can be achieved with limited training data, and the time to train the new model can be reduced.

2.2. Knowledge Distillation

Knowledge distillation (e.g., as described in [3]) is a transfer learning method which is used to distill different knowledge from different ML models into one single model. The common application of the knowledge distillation is a model compression where knowledge from a large ensemble of models with high generalization is distilled into a smaller model which is faster to run inference on. The method can be characterized as a teacher/student scenario where the student (e.g., the smaller model) learns from the teacher (e.g., the large ensemble of models), rather than just learning hard facts from a book, and thus the student obtains deeper knowledge through the learning.

The method may be implemented by using common technique(s) (e.g., stochastic gradient descent) used for training ML models. The difference between the conventional ML model training and the knowledge distillation method is that instead of using the true output values as target values for the ML model training, the output values of the teacher models are used as the target values for the ML model training.

In a scenario where it is desirable to maintain the knowledge from an old model but at the same time to perform a ML model training using new training data, the output of the old model—the teacher model—may be mixed with the new training data and the new model may be trained based on the interpolation between the output of the teacher model and the new training data, thereby training/teaching the new model to mimic the behavior of the old model while learning from the new training data.

Knowledge distillation has been used to share and transfer knowledge between client models in a way similar to the way federated learning (e.g., as described in [4]) handles a continual learning when new data has been acquired. The knowledge distillation may be performed by distilling knowledge from all client (e.g., local) models to produce a more general global (e.g., cloud) model and then by distilling knowledge from the global model to each client model and then by repeatedly performing these steps. In the knowledge distillation, there is no deletion of old data and requires a cloud level dataset to perform the cloud distillation step.

### 3. Problems with Existing Solutions for Federated Learning

Storage limitations: Storage facilities in a client computing device (i.e., the available storage space in a base station) are limited. Accordingly, in order to continuously collect new data at the client computing device, older data stored in the client computing device must be deleted to give space to the new data.

Lost knowledge: A ML model holds knowledge of the data on which the ML model has been trained. As the ML model is continuously trained on new data, however, the knowledge of old data slowly diminishes.

Lacking specific knowledge: Even though a ML model can be continuously trained using new data to gain knowledge, there may be a situation where the ML model can benefit from learning specific knowledge about a problem at hand, which may not be available or present in the new data. The lack of this specific knowledge may degrade the performance of the ML model.

Unstable model: After an old ML model is updated by using new data, the updated new ML model may not show the high performance that the old ML model used to show due to loss of knowledge. Therefore, using a local model (e.g., W_{L}) as the deployment model may be risky since the performance of the local model cannot be controlled.

### 4. Brief Summary of the Embodiments

ML models (e.g., prediction ML models) may be continuously updated by using data which is continuously collected. If a storage space storing the collected data, however, is limited, not all collected data may be stored, and thus not all collected data may be accessible for ML model updates. Therefore, the knowledge of the old data—the data that has already been used for the ML model updates—can only be found in the existing ML models that were trained using the old data. Performing the ML model updates using only the new data, however, may cause the ML models to lose their knowledge of the old data and thus lose its general capacity, thereby risking the ML model to perform poorly.

Embodiments of this disclosure provide stable updates to the ML model. Through the stable updates, the knowledge of the old data in the ML model may be retained while allowing the ML model to be updated (i.e., trained) using the new data. Furthermore, in some embodiments, specific knowledge contained in a special ML model may be practically transferred to a deployed model.

Also, in some embodiments, the locally deployed model is separated from the local model used in the federated learning training, thereby allowing the local model to make careful updates such that the performance of the model is kept stable.

Furthermore, in some embodiments of this disclosure, by using a previously deployed ML model in a fine-tuning stage, the knowledge associated with the old data may be preserved even when the ML model is updated by using new data. For example, a transfer learning method (e.g., knowledge distillation) may be applied to merge the knowledge associated with the new data and the knowledge associated with the previously deployed model.

Specific knowledge may be aggregated into a deployed model to improve the performance, e.g., the knowledge of seasonality or clusters. By leveraging a transfer learning method, e.g., knowledge distillation, the specific knowledge can be integrated from saved models (e.g., a model from last season, a cluster, etc.) which differs for each scenario.

In one aspect there is provided a method performed by a client computing device. The method may comprise obtaining a first machine learning (ML) model. The first ML model may be configured to receive input data set and to generate first output data set based on the input data set. The method may further comprise training a second ML model based at least on the input data set and the first output data set, obtaining, as a result of training the second ML model, a third ML model, and deploying the third ML model.

In another aspect, there is provided a method performed by a client computing device. The method may comprise deploying a first machine learning (ML) model, after deploying the first ML model, training a local ML model, thereby generating a trained local ML model, transmitting to a control entity the trained local ML model, training the deployed first ML model using the trained local ML model, thereby generating an updated first ML model, and deploying the updated first ML model.

In another aspect, there is provided a computer program comprising instructions which when executed by processing circuitry cause the processing circuitry to perform any of the methods described above.

In another aspect, there is provided a carrier containing the computer program described above. The carrier may be one of an electronic signal, an optical signal, a radio signal, and a computer readable storage medium.

In another aspect, there is provided an apparatus. The apparatus may be configured to obtain a first machine learning (ML) model. The first ML model may be configured to receive input data set and to generate first output data set. The apparatus may be further configured to train a second ML model based at least on the input data set and the first output data set, obtain, as a result of training the second ML model, a third ML model, and deploy the third ML model.

In another aspect, there is provided an apparatus. The apparatus may be configured to deploy a first machine learning (ML) model, after deploying the first ML model, train a local ML model, thereby generating a trained local ML model, transmit to a control entity the trained local ML model, train the deployed first ML model using the trained local ML model, thereby generating an updated first ML model, and deploy the updated first ML model.

In another aspect, there is provided an apparatus. The apparatus may comprise a memory and processing circuitry coupled to the memory. The apparatus may be configured to perform any of the methods described above.

### 5. Exemplary Advantages of the Embodiments

The methods and systems according to some embodiments of this disclosure allow performing stable model updates using new data in a scenario where the data that produced the existing model is no longer available. Also, they allow making models to adapt to a specific environment or season easily by transferring knowledge from models having this specific knowledge.

The advantages offered by the embodiments can be summarized as follows.

Knowledge from old data, kept in the model, can be preserved when updating on new data even without access to the old data.

Existing models can benefit from newly acquired data without the risk of decreased performance.

The deployed model will stay stable since it is kept away from training of the federated model.

Specific knowledge, for example season specific knowledge, from existing models can be incorporated into the deployed model.

### BRIEF DESCRIPTION OF THE DRAWINGS

The accompanying drawings, which are incorporated herein and form part of the specification, illustrate various embodiments.

FIG. 1 is a curve showing energy consumption.

FIG. 2 shows a traffic distribution across sites in a network.

FIG. 3 shows a traffic distribution across sites in a network.

FIG. 4 shows varying network traffic load during the day.

FIG. 5 shows examples of base station energy consumption.

FIG. 6 illustrate the Federated Learning (FL).

FIG. 7A shows an exemplary system for updating ML models.

FIG. 7B shows an exemplary method for updating ML models.

FIG. 8A shows a system for updating ML models.

FIG. 8B shows a method for updating ML models

FIG. 9 shows cell sleep mode end-to-end operation sequence

FIG. 10 shows a simple exemplary ML model.

FIG. 11 shows a process according to some embodiments.

FIG. 12 shows a process according to some embodiments.

FIG. 13 shows an apparatus according to some embodiments.

FIG. 14 shows a network node according to some embodiments.

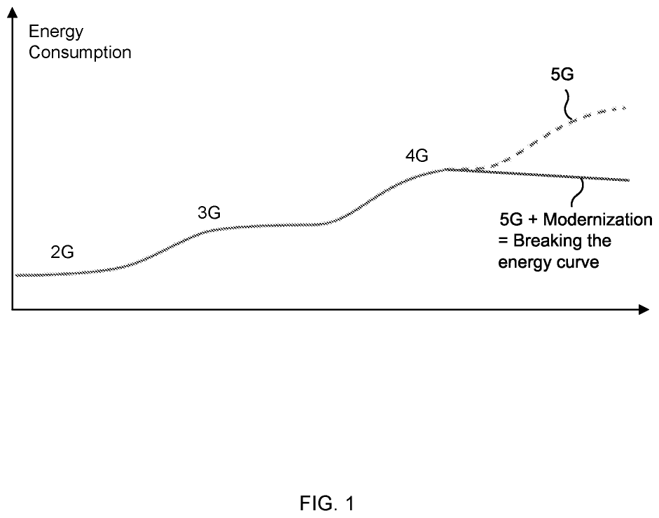

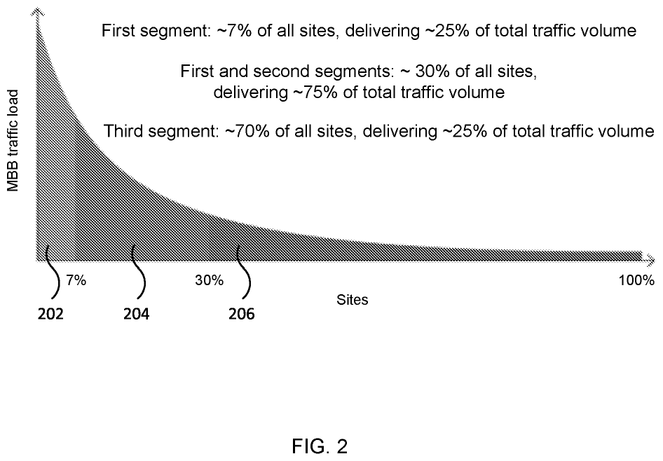

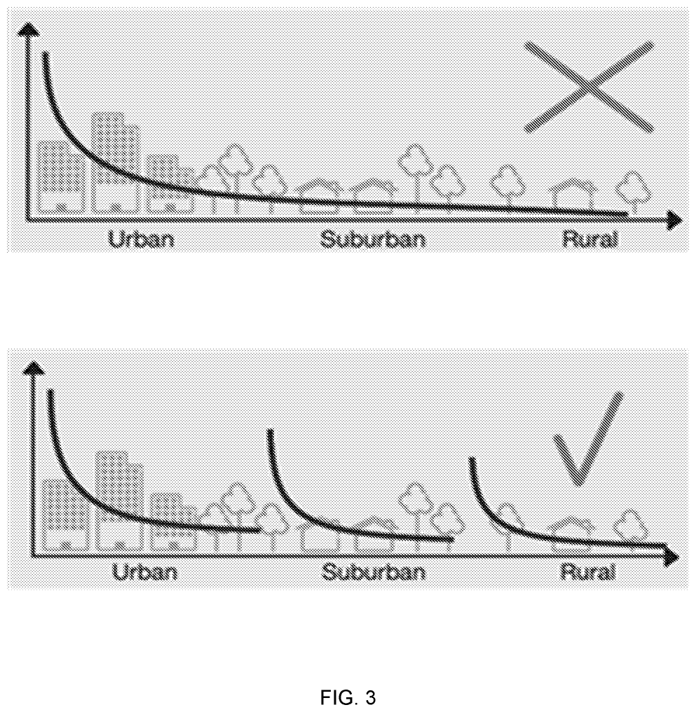

### DETAILED DESCRIPTION

### 6. Exemplary Method and System for Updating ML Models

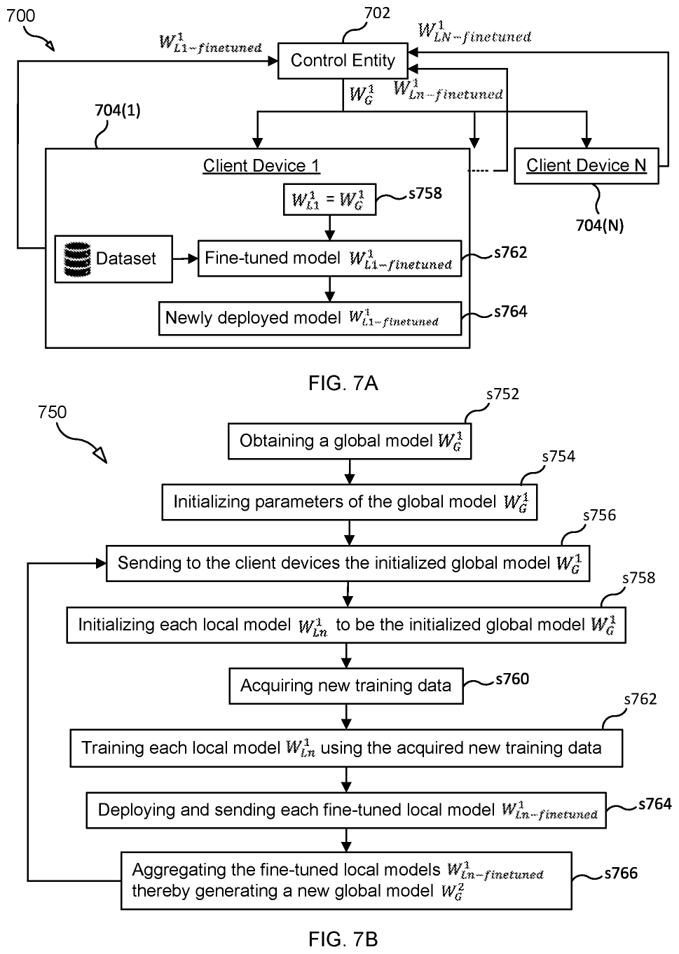

FIG. 7A shows an exemplary system 700 for updating ML models associated with a plurality of client computing devices 704.

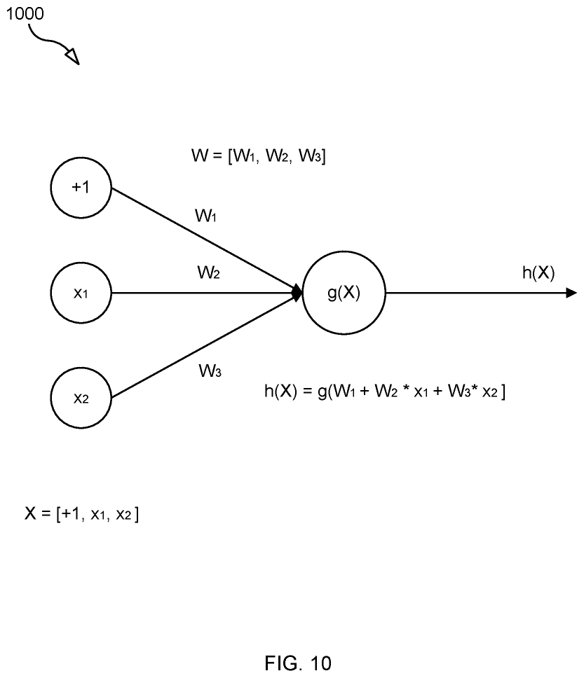

An ML model is an algorithm capable of learning and adapting to new input data with reduced or without human intervention. In this disclosure, an ML model and a model are interchangeably used to refer to such algorithm. FIG. 10 shows an exemplary simple ML model 1000. In the ML model 1000, a vector X corresponds to input data, a vector W corresponds to weights of the ML model 1000, g(X) corresponds to a hidden layer function, and h(X) corresponds to an output of the ML model 1000.

Referring back to FIG. 7A, the system 700 comprises at least a control entity 702 and the plurality of client computing devices 704. The plurality of client computing devices 704 includes a first client computing device 704(1) through the last client computing device 704(N), where N is the number of client computing devices included in the system 700. The control entity 702 may be any node (e.g., a server or an entity providing a server function) having a connection to a network via any suitable interfaces. The entity may be a hardware, a software, or a combination of a hardware and a software.

In case the control entity 702 is an entity providing a server function, in one example, the control entity 702 may be included in eNB, and the X2 interface may be used for communication between the server function and client computing devices 704. In another example, the control entity 702 may be included in the Core Network (MME or S-GW), and the Si interface may be used for communication between the server function and client computing devices 704. In other example, the control entity 702 may be included in Ericsson™ Network Manager (ENM), and the existing OAM interface may be used for communication between the server function and client computing devices 704.

The control entity may be a single unit located at a single location or may comprise a plurality of units which are located at different physical locations but are connected via a network. For example, the control entity 702 may comprise multiple servers each of which communicates with a group of one or more client computing devices 704.

Each client computing device 704 may be any electronic device capable of communicating with the control entity 702. For example, the client computing device 704(1) may be a base station (e.g., eNB, gNB, etc). Even though FIG. 7A shows that each client computing device 704 communicates with the single control entity 702, each client computing device 704 may be configured to communicate with multiple control entities such that it can be a part of training multiple ML models. Also, in some embodiments, each client computing device 704 may correspond to a cluster (group) of client units.

FIG. 7B shows an exemplary process 750 performed by the system 700. The process 750 may begin with step s752.

In the step s752, the control entity 702 may obtain a global model W_{G}¹.

After obtaining the global model W_{G}¹, in step s754, parameters (e.g., weights) of the global model W_{G}¹ are initialized. There are different ways of initializing the parameters. For example, the parameters of the global model W_{G}¹ may be initialized randomly.

After initializing the parameters of the global model W_{G}¹, in step s756, the control entity 702 may send to the client computing devices 704 the initialized global model W_{G}¹.

After receiving the initialized global model W_{G}¹, in step s758, each of the client computing devices 704 may initialize (or configure) its local model W_{Ln}¹ to be same as the initialized global model W_{G}¹. Here, n corresponds to an index of the client computing device included in the system 700. Thus, the first client computing device 704(1) is associated with the local model W_{L1}¹ while the last client computing device 704(N) is associated with the local model W_{LN}¹.

After each of the client computing devices 704(n) configures its local model W_{Ln}¹, in step s760, each of the client computing devices 704 acquires new training data available locally at each of the client computing devices 704. The step s760 may be performed at any time before performing the step s762.

After acquiring the new training data, in step s762, each of the client computing devices 704 fine-tunes (i.e., trains) the local model W_{Ln}¹ using the new training data.

After training the local model W_{Ln}¹, in step s764, each of the client computing devices 704 deploys the fine-tuned local model W_{Ln-finetuned}¹ and sends the fine-tuned local model to the control entity 702. For example, if the client computing device 704(1) is a base station and its fine-tuned local model W_{L1-finetuned}¹ is an algorithm for predicting traffic load at the base station, deploying the fine-tuned local model W_{L1-finetuned}¹ means using the fine-tuned local model W_{L1-finetuned}¹ at the client computing device 704(1) to predict the traffic load at the client computing device 704(1). Alternatively or additionally, the fine-tuned local model W_{L1-finetuned}¹ may be used to set optimal thresholds for various operations of the base station and/or to determine whether to switch network equipment corresponding to the base station on or off.

After receiving the fine-tuned local model W_{Ln-finetuned}¹ from each of the client computing devices 704, in step s766, the control entity 702 aggregates the fine-tuned models W_{Ln-finetuned}¹ tuned using an algorithm (e.g., the common FedAVG algorithm as described in [5]), and generates a new global model W_{G}².

The fine-tuned local models W_{Ln-finetuned}¹ received from the client computing devices 704 may be aggregated in various ways. For example, the fine-tuned local models W_{Ln-finetuned}¹ may be aggregated by averaging the weights of the fine-tuned models W_{Ln-finetuned}¹ (i.e., the weights of W_{L1-finetuned}¹, W_{L2-finetuned}¹, W_{L3-finetuned}¹, . . . , W_{LN-finetuned}¹). This averaging may be a weighted averaging. The weights of the weighted averaging may be determined based on the number and/or the amount of data used for the training the local model at each of the client computing devices 704. For example, if the fine-tuned local model W_{L1-finetuned}¹ received from the client computing device 704(1) was trained using a greater amount of local data as compared to the fine-tuned local model W_{L2-finetuned}¹ received from the client computing device 704(2), a higher weight may be given to the fine-tuned local model W_{L1-finetuned}¹ as compared to the fine-tuned local model W_{L2-finetuned}¹.

After obtaining the global model W_{G}², the process 750 may return to the step s756 and may repeat the steps s756-s766 until the global model W_{G}^{t} generated at the step s766 converges. Here, the variable “t” indicates the number of repetitions of performing the steps s756-s766. Thus, when the steps s756-766 are initially performed, the models involved in the steps may be labeled as W_{G}¹, W_{Ln}¹, and W_{Ln-finetuned}¹, and when the steps s756-766 are performed t−1 times, the models involved in the steps may be labelled as W_{G}^{t-1}, W_{Ln}^{t-1}, and W_{Ln-finetuned}^{t-1}.

Whether the global model W_{G}^{t} has converged or not may be determined based at least on how well the fine-tuned local models perform on the local data. For example, the control entity 702 may determine that the global model W_{G}^{t} has converged when the performances of the locally fine-tuned models derived based on the global model W_{G}^{t} indicate that a particular number and/or a percentage of the locally fine-tuned models performed better than a convergence threshold (e.g., a threshold number and/or a threshold percentage of client computing devices for finding the convergence).

### 7. Improved Method and System for Updating ML Models

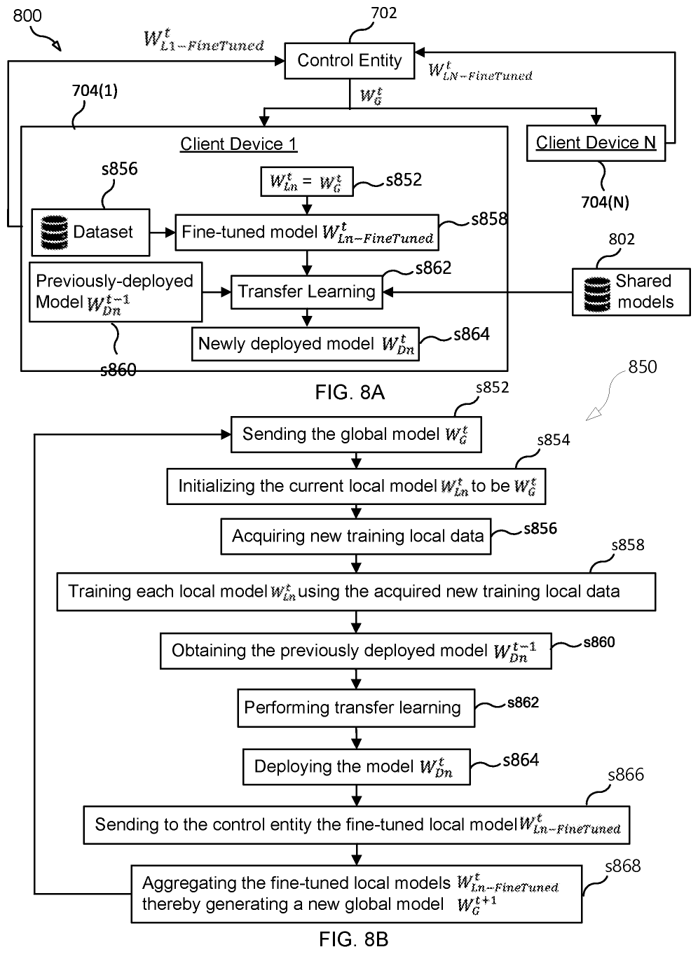

FIG. 8A shows a system 800 for updating ML models associated with the plurality of client computing devices 704, according to some embodiments of this disclosure. The system 800 comprises at least the control entity 702 and the plurality of client computing devices 704.

Like the system 700 shown in FIG. 7A, in the system 800, the control entity 702 and the client computing devices 704 may initially perform the steps s752-s766 (which constitute a first training cycle) and then may repeatedly perform the steps s756-s766 (which constitute a subsequent training cycle) until the global model W_{G}^{t} generated at the step s766 converges. If the global model W_{G}^{t} converges at the step s766 in the first training cycle, the subsequent training is not needed (i.e., there is no need to repeatedly perform the steps s756-s766).

As discussed above, since each client computing device 704 includes a limited storage, each client computing device 704 may be able to store data only over a certain time window. For example, in case each client computing device 704 is a base station, there may be a scenario where at least some of the base stations can store data regarding network traffic load only for a particular time period (e.g., two weeks). The time period may be based on available storage (e.g., the storage available at each client computing device 704) and/or time resolution of data (e.g., the time duration of collecting data).

For example, when the ML models are related to energy-saving software features, data that is needed for training the ML models may be collected in multiple time resolutions: ranging from sub-milliseconds to support MSTx and LESS to aggregates of 100 ms, 1 min and 15 min aggregates to support MSM, Massive MIMO Sleep Mode and CSM. The time resolutions need to be selected to suite the specific task (e.g., by using hyperparameter search). Examples of collected data to support the MSTx and LESS relate to the scheduler; number of Physical Resource Blocks (PRBs) to schedule, packet delay time, the number of UEs with data in the buffer, and scheduled volume, the size and inter-arrival time of packets per active UE, latency sensitive services, and other relevant information. Examples of collected data to support MSM, Massive MIMO Sleep Mode, and CSM relate to the scheduler on an aggregated level; percent of scheduled PRBs, number of connected users, schedule traffic volume and throughput, number of scheduled users, Main Processor (MP) load, and other relevant information.

In some cases, after the particular time period (e.g., two weeks) has passed since the old training data was saved in the client computing device (e.g., 704(1)), the client computing device 704(1) may have to collect new training data and to store the new training data locally. But because the client computing device 704(1) has a limited storage, the client computing device may have to overwrite the stored old training data in order to store the new training data. If the old training data is overwritten, however, the old training data—the data used to produce the W_{D}—would no longer be accessible. Thus, the knowledge associated with the old training data would be lost, thereby degrading the performance of the ML models.

Therefore, according to some embodiments, after obtaining the converged global model W_{G}^{t} at the step s766, the system 800 may perform the process 850 shown in FIG. 8B. The process 850 may begin with step s852.

In the step s852, the control entity 702 sends to the client computing devices 704 the converged global model W_{G}^{t}.

After receiving the global model W_{G}^{t}, in step s854, each client computing device 704 initializes (i.e., configures) its current local model W_{Ln}^{t}, to be same as the global model W_{G}^{t}.

After each client computing device 704 initializes its current local model W_{Ln}^{t}, in step s856, each client computing device 704 obtains and stores new training data locally available at each client computing device 704. The new training data may be stored in the storage medium of each client computing device 704 or may be stored in a cloud and accessed/retrieved from the cloud by each client computing device 704. Optionally, each client computing device 704 may delete the old training data stored at each client computing device 704.

The step s856 may be performed at any time before performing the step s858.

In step s858, each client computing device 704 fine-tunes (i.e., trains) its current local model W_{Ln}^{t} using the new training data locally available at each client computing device, thereby generating a fine-tuned local model W_{Ln-FineTuned}^{t}.

In step s860, each client computing device 704 obtains the previously-deployed stable model W_{Dn}^{t-1}. For example, the previously-deployed model W_{Dn}^{t-1} may be stored in a storage medium of each client computing device 704 and each client computing device 704 may retrieve the previously-deployed model from the storage medium in the step s860. As explained above, the model W_{Dn}^{t-1} is the model that was deployed in the step s764 of the (t−1)th training cycle. Even though FIG. 8B shows that the step s860 is performed after performing the step s858, the step s860 may be performed before or at the same time as the step s858.

In step s862, a transfer learning is performed to generate a new deployed model. W_{Dn}^{t}. The transfer learning may be performed based on the previously-deployed model W_{Dn}^{t-1} and the fine-tuned local model W_{Ln-FineTuned}^{t}.

In some embodiments, the transfer learning may be performed through knowledge distillation process. In such embodiments, the fine-tuned local model W_{Ln-FineTuned}^{t} may be used as a “teacher” model and the previously-deployed model W_{Dn}^{t-1} may be used as a “student” model.

Specifically, if the fine-tuned local model W_{Ln-FineTuned}^{t} outputs output data_{teacher} based on input data_{general}, in the knowledge distillation process, the previously-deployed model W_{D}^{t-1} may be trained (i.e., adjusted) to output, based on the input data_{general}, output data_{student} that is same as or similar to the output data_{teacher} Training the previously-deployed model W_{Dn}^{t-1} may comprise adjusting parameters of the model W_{Dn}^{t-1} such that the model W_{Dn}^{t-1} generates the output data_{student} that is same as or similar to the output data_{teacher} The output data_{student} and the output data_{teacher} may be construed as being similar to each other if the difference between them is less than and/or equal to a threshold value.

In another example, the fine-tuned local model W_{Ln-FineTuned}^{t} may be used as a “student” model and the previously-deployed model W_{Dn}^{t-1} may be used as a “teacher” model. Specifically, if the previously-deployed model W_{Dn}^{t-1} outputs output data_{teacher} based on input data_{general}, in the knowledge distillation process, the fine-tuned local model W_{Ln-FineTuned}^{t} may be trained (i.e., adjusted) to output, based on the input data_{general}, output data_{student} that is same as or similar to the output data_{teacher}. Training the fine-tuned local model W_{Ln-FineTuned}^{t} may comprise adjusting parameters of the model W_{Ln-FineTuned}^{t} such that the model W_{Ln-FineTuned}^{t} generates the output data_{student} that is same as or similar to the output data_{teacher}. The output data_{student} and the output data_{teacher} may be construed as being similar to each other if the difference between them is less than and/or equal to a threshold value.

In some embodiments, additional model(s) 802 may be used to perform the transfer learning in the step s862. The additional model(s) 802 may provide specific knowledge to each client computing device 704.

For example, each client computing device 704 may be a base station and the model deployed at each client computing device 704 may be a ML model for predicting a traffic load in each region associated with each client computing device 704 for a particular month.

There may be, however, differences in each client computing device's environment between weather seasons. For example, the traffic load during the spring or the fall would be much higher than the traffic load during the winter as more people stay outside in the spring or the fall. In such case, a ML model configured to predict a traffic load during a particular season may be useful in the transfer learning because it may provide useful specific knowledge associated with the particular season to the transfer learning.

Thus, in some embodiments, the system 800 may comprise a cloud storage 820 in which different knowledge specific models are stored. In other embodiments, the knowledge specific models may be stored locally at some or all client computing devices. The stored knowledge specific models may include a first ML model for predicting network traffic load in a particular region during the first week of a new year and a second ML model for predicting network traffic load in the particular region during the Christmas week.

Upon the occurrence of a triggering condition (e.g., receiving a command from the control entity 702, determining that a particular season, month, date has started, etc), each client computing device 704 may select a knowledge specific model from the knowledge specific models stored in the cloud storage and use it for the transfer learning. Detecting the occurrence of the triggering condition may be based on a rule or an output of a separate ML model configured to determine the timing of using the additional model 802 (i.e., the knowledge specific model).

Specifically, each client computing device 704 may select and retrieve a knowledge specific model W_{Sn} by sending a request for the particular knowledge specific model W_{Sn} and receiving model data corresponding to the selected knowledge specific model W_{Sn}. Alternatively, each client computing device 704 may receive the model data corresponding to the knowledge specific model W_{Sn} periodically or when a particular triggering condition is satisfied. For example, the control entity 702 may trigger the transmission of the model data based on determining that a particular event has occurred.

In case an additional model 802 is used to perform the transfer learning in the step s862, the additional model 802 may be used as a “teacher” model for the knowledge distillation.

Referring back to the scenario where the fine-tuned local model W_{Ln-FineTuned}^{t} is used as a “teacher” model and the previously-deployed model W_{Dn}^{t-1} is used as a “student” model, the fine-tuned local model W_{Ln-FineTuned}^{t} may output output data_{teacher1} based on input data_{general}. Similarly, if the additional model 802 is used as another “teacher” model, the additional model 802 may output output data_{teacher2} based on input data_{general}. In this scenario, the transfer learning may be performed by training the previously-deployed model W_{Dn}^{t-1}—adjusting parameters of the model W_{Dn}^{t-1}—such that the model W_{Dn}^{t-1} generates the output data_{student} that is same as or similar to the average (or the weighted average) of the output data_{teacher1} and output data_{teacher2}. The output data_{student} and the average (or the weighted average) of the output data_{teacher1} and output data_{teacher2} may be construed as being similar to each other if the difference between them is less than and/or equal to a threshold value. In some embodiments, the importance of the fine-tuned model and the knowledge specific model in the transfer learning process may be adjusted by weighting the average of their outputs differently. Also, the stability of the deployed model may be adjusted by adjusting the amount of the knowledge of the teacher models used in the transfer learning process.

On the other hand, in the scenario where the fine-tuned local model W_{Ln-FineTuned}^{t} is used as a “student” model and the previously-deployed model W_{Dn}^{t-1} is used as a “teacher” model, the previously-deployed model W_{Dn}^{t-1} may output output data_{teacher1} based on input data_{general}. Similarly, if the additional model 802 is used as another “teacher” model, the additional model 802 may output output data_{teacher2} based on input data_{general}. In this scenario, the transfer learning may be performed by training the fine-tuned local model W_{Ln-FineTuned}^{t}—adjusting parameters of the model W_{Ln-FineTuned}^{t}—such that the model W_{Ln-FineTuned}^{t} generates the output data_{student} that is same as or similar to the average (or the weighted average) of the output data_{teacher1} and output data_{teacher2}. The output data_{student} and the average (or the weighted average) of the output data_{teacher1} and output data_{teacher2} may be construed as being similar to each other if the difference between them is less than and/or equal to a threshold value. In some embodiments, the importance of the previously-deployed model and the knowledge specific model in the transfer learning process may be adjusted by weighting the average of their outputs differently.

Through the transfer learning, the deployment model of each client computing device 704 may be carefully updated while ensuring the stable performance of the deployment model.

In some embodiments, the additional model 802 (i.e., the shared model) may be updated. For example, the additional model 802 may be updated using the fine-tuned local model W_{Ln-FineTuned}^{t} and the previously-deployed model W_{Dn}^{t-1} of one or more client computing devices 704. Specifically, at each client computing device 704, the additional model 802 may be trained by (i) setting the additional model 802 as a “student” model, and the fine-tuned local model W_{Ln-FineTuned}^{t} and the previously-deployed model W_{Dn}^{t-1} as “teacher” models, and (ii) performing the knowledge distillation process described above. Then a new global shared model may be generated (i.e., the additional model 802 may be updated) by aggregating the additional model 802 trained at each client computing devices. Any appropriate aggregation technique (e.g., like the ones described above) may be used for generating the new global shared model.

In other embodiments, the transfer learning in step s862 may be performed by using (i) the previously-deployed model W_{Dn}^{t-1} as a “student” model and (ii) the fine-tuned local model W_{Ln-FineTuned}^{t} and the previously-deployed model W_{Dn}^{t-1} (and optionally the additional model 802) as “teacher” models. For example, if the previously-deployed model W_{Dn}^{t-1} is configured to produce output data #1 based on an input data and the fine-tuned local model W_{Ln-FineTuned}^{t} is configured to produce output data #2 based on the input data, the previously-deployed model W_{Dn}^{t-1} may be trained such that it outputs an average or a weighted average of the output data #1 and #2 (and optionally the output of the additional model 802) based on the input data.

Furthermore, in different embodiments, the transfer learning in step s862 may be performed by using (i) the previously-deployed model W_{Dn}^{t-1} as a “student” model, (ii) the fine-tuned local model W_{Ln-FineTuned}^{t} as a “teacher” model, and (iii) ground-truth labels which may correspond to ideal or expected output data given an input data. For example, if the fine-tuned local model W_{Ln-FineTuned}^{t} is configured to produce output data based on input data, the previously-deployed model W_{Dn}^{t-1} may be trained such that it outputs the same output data given the input data. Additionally, in a separate process, the previously-deployed model W_{Dn}^{t-1} may be trained such that it outputs the ground-truth labels given the input data. After training the previously-deployed model W_{Dn}^{t-1} using two different process, the final updated-deployed model W_{Dn}^{t} may be obtained by averaging or weighted averaging the two previously-deployed models W_{Dn}^{t-1} that are trained through the two different processes (one using the fine-tuned local model W_{Ln-FineTuned}^{t} and another one using the ground-truth labels).

In some embodiments, the frequency of performing the step s858—training the local model—and the frequency of performing the step s862—the transfer learning—may be different. For example, the step s858 may be performed as frequently as three times of the frequency of performing the step s862.

After performing the step s862, in step s864, each client computing device 704 deploys the model W_{Dn}^{t} generated in the step s862. As discussed above, the new deployment model W_{D}^{t} incorporates knowledge from the model W_{Ln}^{t} and optionally the model W_{Sn}.

In step s866, each client computing device 704 sends to the control entity 702 the fine-tuned local model W_{Ln-FineTuned}^{t} which is generated in the step s858.

In step s868, after the control entity 702 receives the fine-tuned local model W_{Ln-FineTuned}^{t} from each client computing device 704, the control entity 702 aggregates the received fine-tuned local models W_{Ln-FineTuned}^{t} by using an algorithm (e.g., the common FedAVG algorithm as described in [5]) and generates a new global model W_{G}^{t+1}.

After performing the step s868, the process 850 may return to the step s852, and the steps s852-s868 may be performed repeatedly.

### 8. Use Case—Continuous Learning for Energy-Saving Software

The method according to the embodiments of this disclosure may be used to achieve the above discussed goal of meeting the massive traffic growth challenge and lowering total mobile network energy consumption. In achieving the discussed goal, the following conclusions may be considered.

(1) Energy savings can be made at all sites, not only the sites carrying the most traffic. Thus, it is needed to consider traffic demand and growth of every site (regardless of the location) individually.

(2) Equipment can be switched on and off on different time scales, ranging from micro-seconds to minutes. Thus, energy-saving software can contribute substantially to lowered energy consumption.

To take traffic demand and growth of every site individually into consideration, it is important to incorporate information on geographical location and configuration data (e.g., activated features, Tx/Rx configurations, bands, etc.) in a ML model. Configuration data would only need to be updated as configurations change.

To lower energy consumption, the following 4G and 5G energy saving features may be considered: Micro Sleep Tx (MSTx), Low Energy Scheduler Solution (LESS), MIMO

Sleep Mode (MSM), Cell Sleep Mode (CSM), and Massive MIMO Sleep Mode. The common aspect of these features is that they save power by disabling transmissions over the air during certain time periods. The features may be configured to be offline using thresholds related to traffic demand. The solution described below can be trained to find the optimal thresholds for individual sites and features, or to make decisions on when to switch on and off equipments based on, for example, traffic demand forecast. The first alternative enables ML models to be used in the existing product solution while the second alternative would enable greater gains by enabling a solution that is not bound to the existing thresholds parameters.

As the operating network and the operating environment evolve, the traffic demand may change, thus impacting the energy saving features of a base station operating in the network and/or the environment. To accommodate these changes in traffic demand, it is important to introduce a mechanism for automated continuous learning.

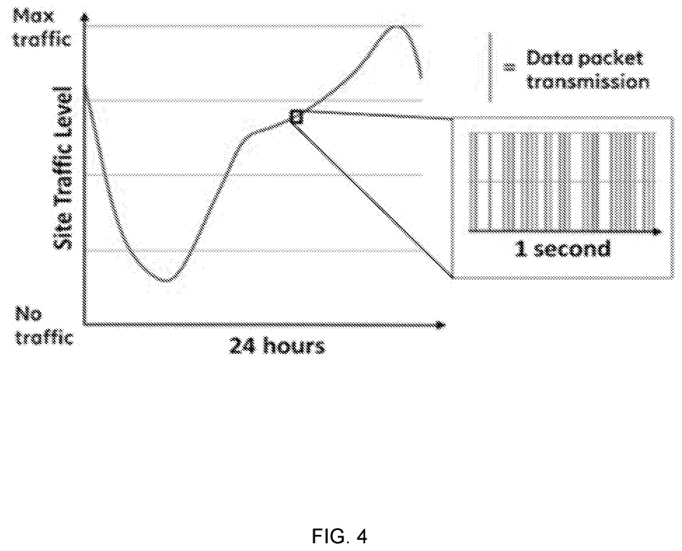

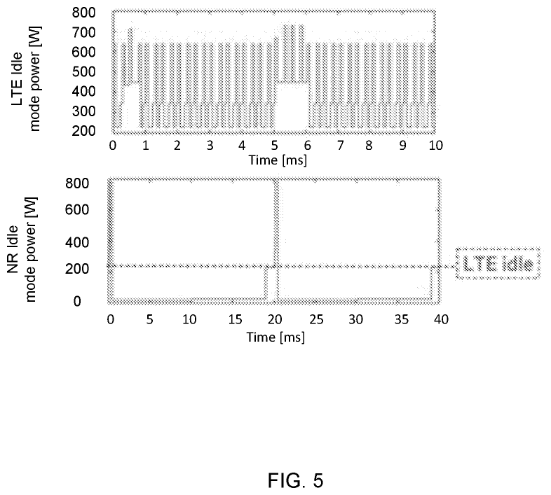

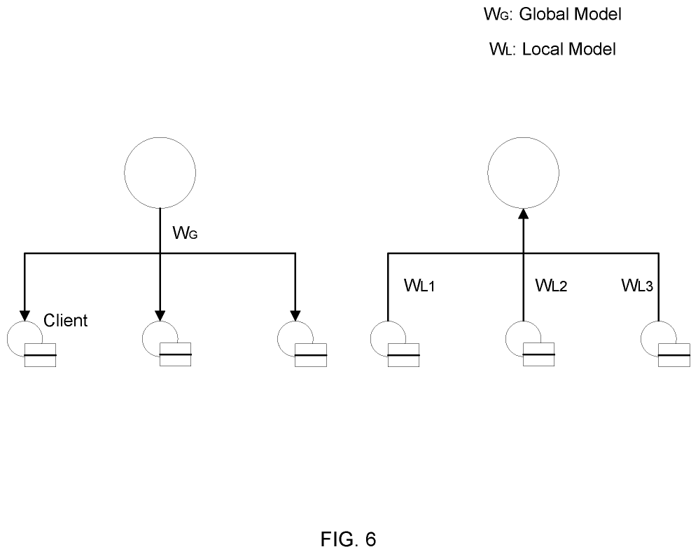

Micro Sleep Tx (MSTx) in combination with Low Energy Scheduler Solution: MSTx acts on a micro-second time frame, saving energy by switching off the power amplifiers on a symbol-time basis when no user data needs to be transmitted on downlink. LESS acts on a sub-millisecond time frame and increases the number of blank subframes where no traffic data transmitted. A blank subframe consumes less energy, therefore more blank subframes save more energy. LESS is a scheduling solution that benefits from information on the overall traffic demand on a cell level as well as the demand of individual users. FIG. 4 shows varying network traffic load during the day. The user demand is dependent on the services the users consume and may be predictable based on features such as IP packet size and inter-arrival times. Due to the operating time scale of these features, the time period of data storage is limited. The shared models described above can be used to incorporate many different aspects, ranging from event behavior (e.g. sport and concert events), high and low load periods, specific service behavior etc.

MIMO Sleep Mode (MSM) and Massive MIMO Sleep Mode: MSM automatically changes a MIMO configuration to a smaller MIMO or a SIMO configuration when low traffic conditions are detected in the cell. Massive MIMO Sleep Mode deactivates one or several M-MIMO antenna elements, depending on traffic needs. Both features benefit from information on the overall traffic demand on a cell level (e.g., as shown in FIG. 4). The operating time scale of these features is slightly larger compared to MSTx and LESS, allowing the time period of data storage to be longer. The shared models described above can be used to incorporate seasonal information, daily, weekly and yearly (split in e.g. month of year as describe in the seasonality example provided above) seasonality, as well as holiday and specific event behavior (e.g. sport and concert events).

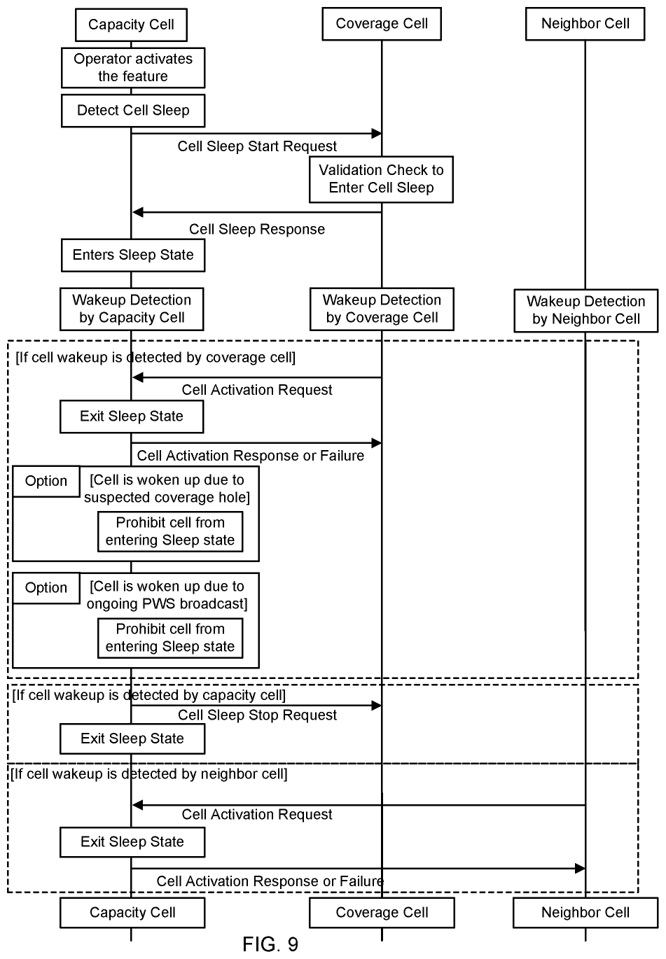

Cell Sleep Mode: Cell Sleep Mode detects low traffic conditions for capacity cells and turn the capacity cells on/off depending on the conditions. Similar to MSM and Massive MIMO Sleep Mode, this feature benefits from information on the overall traffic demand on cell level (e.g., as shown in FIG. 4). The sequence diagram in FIG. 9 illustrates an exemplary operational mode (e.g., as disclosed in [12]). The capacity cell (e.g., the cells deployed to add capacity in an area where there is already coverage from a coverage cell) decides to enter sleep mode based on traffic demand, similar to how MSM and Massive MIMO Sleep Mode works. This similarity enables sharing the same models between these different features.

In the embodiments where the system 800 and the method 850 are used for any of the above three functions—MSTx, MSM, and Cell Sleep Mode—(1) the client computing devices 704 may correspond to base stations; (2) the models involved in the method 850 correspond to ML models for predicting traffic demand at each base station; (3) the dataset available at each client computing device 704 may correspond to data indicating past network usages at the base station during a time period (e.g., a week, a month, a year, etc.); and (4) the additional model 802 may correspond to a ML model configured to predict network usages of any base station during a particular event period or season (e.g., a sports event or a holiday season).

In addition to the capacity cell, two more cells may be involved: coverage cells and neighbor cells. Communication between the cells is enabled through the X2 interface (e.g., as disclosed in [10] and [11]). Both the coverage cells and the neighbor cells have the role of detecting when to wake up the capacity cell. To accommodate this role the shared models 802 can be used to incorporate knowledge on earlier decisions on cell sleep activation and deactivation.

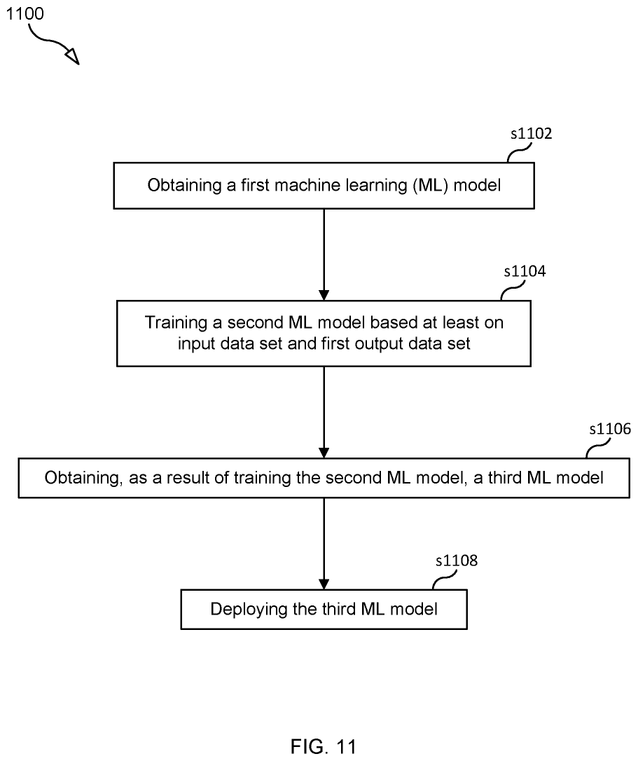

FIG. 11 shows a process 1100 performed by the client computing device 704(n) according to some embodiments. The process may begin with step s1102.

The step s1102 comprises obtaining a first machine learning (ML) model. The first ML model may be configured to receive input data set and to generate first output data set based on the input data set.

Step s1104 comprises training a second ML model based at least on the input data set and the first output data set.

Step s1106 comprises obtaining, as a result of training the second ML model, a third ML model.

Step s1108 comprises deploying the third ML model.

In some embodiments, the process 1100 further comprises obtaining a fourth ML model. The fourth ML model may be configured to receive the input data set and to generate second output data set based on the input data set. The training of the second ML model may comprise training the second ML model based at least on the input data set, the first output data set, and the second output data set.

In some embodiments, the process 1100 further comprises calculating an output average or a weighted output average of (i) data included in the first output data set and (ii) data included in the second output data set. The training of the second ML model may comprise providing to the second ML model the input data set, providing to the second ML model the calculated output average or the calculated weighted output average, and changing one or more parameters of the second ML model based at least on (i) the input data set and (ii) the calculated output average or the calculated weighted output average.

In some embodiments, calculating the weighted output average comprises obtaining a first weight value associated with the data included in the first output data set and obtaining a second weight value associated with the data included in the second output data set. The process 1100 may further comprise changing the first weight value and/or the second weight value based on an occurrence of a triggering condition.

In some embodiments, the process 1100 may further comprise receiving from a control entity global model information identifying a global ML model, training, based at least on the input data set or different input data set, the global ML model, as a result of the training the global ML model, obtaining a local ML model, and transmitting toward the control entity local ML model information identifying the local ML model. The local ML model may be the first ML model or the second ML model.

In some embodiments, the first ML model is one of the local ML model or a specific use-case model, and the second ML model is a currently deployed ML model that is currently deployed at the client computing device.

In some embodiments, the first ML model is one of the local ML model or a specific use-case model, the second ML model is a currently deployed ML model that is currently deployed at the client computing device, and the fourth ML model is another one of the local ML model and (ii) the specific use-case model.

In some embodiments, the first ML model is a specific use-case model or a currently deployed ML model that is currently deployed at the client computing device, and the second ML model is the local ML model.

In some embodiments, the process 1100 may further comprise receiving from a shared storage specific use-case model information identifying the specific use-case model. The specific use-case model may be shared among two or more client computing devices including the client computing device, and the shared storage may be configured to be accessible by said two or more client computing devices.

In some embodiments, the deploying of the second ML model may comprise replacing the currently deployed ML model with the second ML model as the model that is currently deployed at the client computing device.

In some embodiments, the input data set is stored in a local storage element, the local storage element is included in the client computing device, and the process 1100 may further comprise, after deploying the third ML model, removing the input data set from the local storage element.

In some embodiments, the input data set may be removed from the local storage element in response to an occurrence of a triggering condition, and the occurrence of the triggering condition may be any one or a combination of (i) that a predefined time has passed from the timing of storing the input data set at the local storage element, (ii) receiving a removing command signal from the control entity, and (iii) that the amount of storage spaces available at the local storage element is less than a threshold value.

In some embodiments, the specific use-case ML model may be associated with any one or a combination of a particular season of a year, a particular time period within a year, a particular public event, and a particular value of the temperature of the area in which the client computing device is located.

In some embodiments, the client computing device may be a base station, and the third ML model may be a ML model for predicting traffic load in a region associated with the base station.

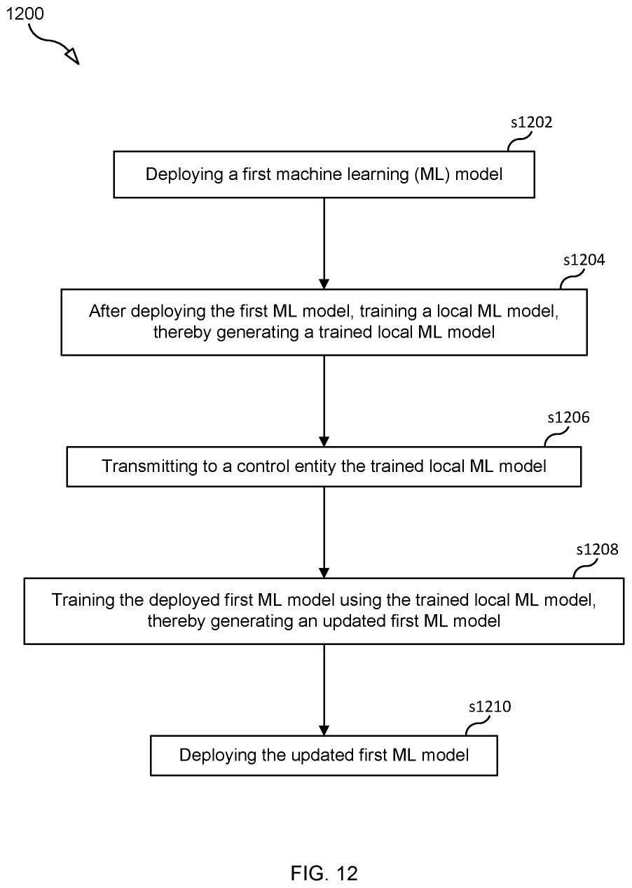

FIG. 12 shows a process 1200 performed by the client computing device 704(n) according to some embodiments. The process may begin with step s1202.

The step s1202 comprises deploying a first machine learning (ML) model.

Step s1204 comprises after deploying the first ML model, training a local ML model, thereby generating a trained local ML model.

Step s1206 comprises transmitting to a control entity the trained local ML model.

Step s1208 comprises training the deployed first ML model using the trained local ML model, thereby generating an updated first ML model.

Step s1210 comprises deploying the updated first ML model.

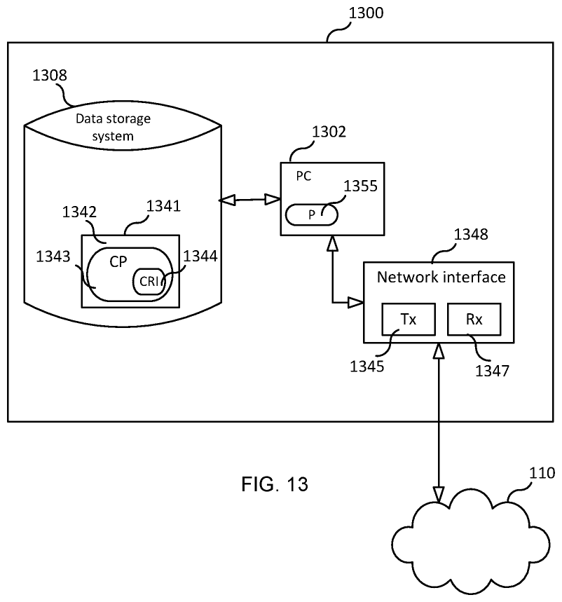

FIG. 13 is a block diagram of an apparatus 1300, according to some embodiments, for implementing the control entity 702. As shown in FIG. 13, apparatus 1300 may comprise: processing circuitry (PC) 1302, which may include one or more processors (P) 1355 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1300 may be a distributed computing apparatus); a network interface 1348 comprising a transmitter (Tx) 1345 and a receiver (Rx) 1347 for enabling apparatus 1300 to transmit data to and receive data from other nodes connected to a network 110 (e.g., an Internet Protocol (IP) network) to which network interface 1348 is connected (directly or indirectly) (e.g., network interface 1348 may be wirelessly connected to the network 110, in which case network interface 1348 is connected to an antenna arrangement); and a local storage unit (a.k.a., “data storage system”) 1308, which may include one or more non-volatile storage devices and/or one or more volatile storage devices. In embodiments where PC 1302 includes a programmable processor, a computer program product (CPP) 1341 may be provided. CPP 1341 includes a computer readable medium (CRM) 1342 storing a computer program (CP) 1343 comprising computer readable instructions (CRI) 1344. CRM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes apparatus 1300 to perform steps described herein (e.g., steps described herein with reference to the flow charts). In other embodiments, apparatus 1300 may be configured to perform steps described herein without the need for code. That is, for example, PC 1302 may consist merely of one or more ASICs. Hence, the features of the embodiments described herein may be implemented in hardware and/or software.

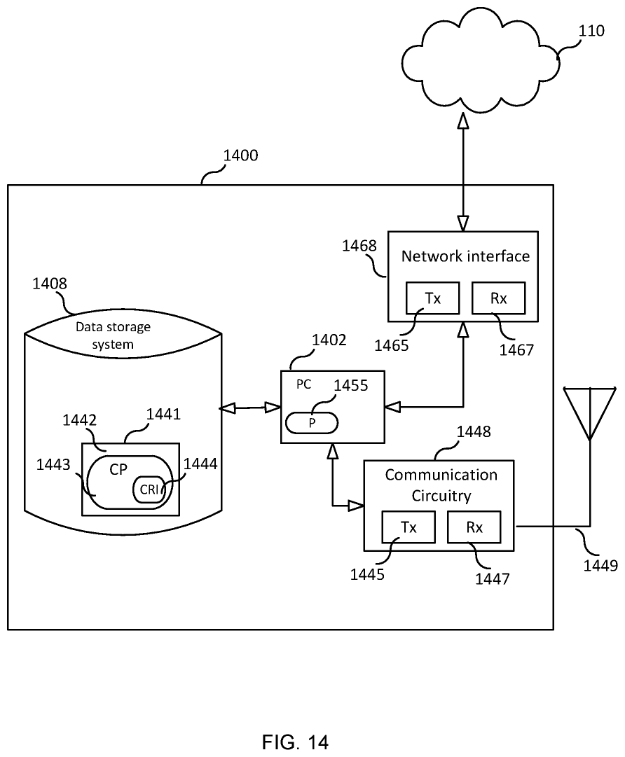

FIG. 14 is a block diagram of a network node that may serve as the client computing device 704(n), according to some embodiments. As shown in FIG. 14, the network node may comprise: processing circuitry (PC) 1402, which may include one or more processors (P) 1455 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 1400 may be a distributed computing apparatus); a network interface 1468 comprising a transmitter (Tx) 1465 and a receiver (Rx) 1467 for enabling apparatus 1400 to transmit data to and receive data from other nodes connected to a network 110 (e.g., an Internet Protocol (IP) network) to which network interface 1448 is connected; communication circuitry 1448, which is coupled to an antenna arrangement 1449 comprising one or more antennas and which comprises a transmitter (Tx) 1445 and a receiver (Rx) 1447 for enabling the network node to transmit data and receive data (e.g., wirelessly transmit/receive data); and a local storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes the network node to perform steps described herein (e.g., steps described herein with reference to the flow charts). In other embodiments, the network node may be configured to perform steps described herein without the need for code. That is, for example, PC 1402 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes and message flows described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### DISCLOSURE

The following table shows abbreviations of acronyms mentioned in this

| Abbreviation | Explanation |
|---|---|
| 3GPP | Third Generation Partnership Project |
| AI | Artificial Intelligence |
| ARIMA | Auto Regressive Integrated Moving Average |
| CSM | Cell Sleep Mode |
| ENIQ | Ericsson Network IQ |
| ERS | Ericsson Radio System |
| FedAvg | Federated Averaging |
| FL | Federated Learning |
| GSM | Global System for Mobile Communications |
| HVAC | Heating, Ventilation, and Air Conditioning |
| LESS | Low Energy Scheduler Solution |
| LTE | Long-Term Evolution |
| MIMO | Multi-Input and Multi-Output |
| ML | Machine Learning |
| MME | Mobility Management Entity |
| MSM | MIMO Sleep Mode |
| MSTs | Micro Sleep Tx |
| OAM | Operations, Administration and Management |
| PM | Performance Management |
| ROP | Recording Output Period |
| Rx | Receive |
| SIMO | Single Input Multiple Output |
| Tx | Transmit |
| NR | New Radio |
| RAN | Radio Access Network |
| S-GW | Serving Gateway |
| WCDMA | Wideband Code Division Multiple Access |

### 9. References

| | |
|---|---|
| 1 | Frenger, P., Tano, R. (2019) “A technical |
| | look at 5G energy consumption and |
| | performance”. https://www.ericsson.com/en/ |
| | blog/2019/9/energy-consumption-5g-nr |
| 2 | Weiss, K., Taghi M. K., DingDing W. |
| | (2016) “A survey of transfer learning.” |
| | Journal of Big data 3.1 (2016): 9. |
| 3 | Hinton, G., Vinyals, O., Dean, J. (2015) |
| | “Distilling the knowledge in a neural |
| | network”. arXiv preprint arXiv: 1503.02531. |
| 4 | Lu, Yan, et al. (2019) “Collaborative |
| | learning between cloud and end devices: |
| | an empirical study on location prediction”. |
| | Proceedings of the 4th ACM/IEEE |
| | Symposium on Edge Computing. |
| 5 | McMahan, H. Brendan, et al. (2016) |
| | “Communication-efficient learning of |
| | deep networks from decentralized data”. |
| | arXiv preprint arXiv: 1602.05629. |
| 6 | Ericsson White Paper. (2020) |
| | “Breaking the energy curve”. |
| | https://www.ericsson.com/494240/assets/ |
| | local/about-ericsson/sustainability- |
| | and-corporate-responsibility/documents/ |
| | 2020/2020-ericsson-breaking-the- |
| | energy-curve-report.pdf |
| 7 | Frenger, P. Tano, R. (2019) “More Capacity |
| | and Less Power: How 5G NR can |
| | Reduce Network Energy Consumption”. |
| | 2019 IEEE 89th Vehicular |
| | Technology Conference. |
| 8 | Frenger, P., Friberg, C., Persson, O., |
| | Jading Y., Olsson M. (2014) “Radio |
| | network energy performance: Shifting |
| | focus from power to precision”. |
| | Ericsson Review 2014:2. |
| 9 | Oreshkin, B., Chapados, N., Carpov, D., |
| | Bengio, Y. (2020) “N-BEATS: |
| | Neural Basis Expansion analysis for |
| | interpretable time series forecasting”. |
| | ICLR 2020. |
| 10 | 3GPP TS 36.423, “X2 Application |
| | Protocol (X2AP)”. Version 9.6.0. |
| 11 | 3GPP TR 36.927, “Potential solutions |
| | for energy saving for E-UTRAN”. |
| | Version 12.0.0. |

1. A method performed by a client computing device, the method comprising:
obtaining a first machine learning (ML) model, wherein the first ML model is configured to receive input data set and to generate first output data set based on the input data set;
training a second ML model based at least on the input data set and the first output data set;
obtaining, as a result of training the second ML model, a third ML model; and
deploying the third ML model.

2. The method of claim 1, the method further comprising:
obtaining a fourth ML model, wherein the fourth ML model is configured to receive the input data set and to generate second output data set based on the input data set, wherein
the training of the second ML model comprises training the second ML model based at least on the input data set, the first output data set, and the second output data set.

3. The method of claim 2, the method further comprising:
calculating an output average or a weighted output average of (i) data included in the first output data set and (ii) data included in the second output data set, wherein
the training of the second ML model comprises:
providing to the second ML model the input data set;
providing to the second ML model the calculated output average or the calculated weighted output average; and
changing one or more parameters of the second ML model based at least on (i) the input data set and (ii) the calculated output average or the calculated weighted output average.

4. The method of claim 3, wherein
calculating the weighted output average comprises:
obtaining a first weight value associated with the data included in the first output data set;
obtaining a second weight value associated with the data included in the second output data set; and
the method further comprises changing the first weight value and/or the second weight value based on an occurrence of a triggering condition.

5. The method of claim 1, the method comprising:
receiving from a control entity global model information identifying a global ML model;
training, based at least on the input data set or different input data set, the global ML model;
as a result of the training the global ML model, obtaining a local ML model; and
transmitting toward the control entity local ML model information identifying the local ML model, wherein
the local ML model is the first ML model or the second ML model.

6. The method of claim 1, wherein
the first ML model is one of the local ML model or a specific use-case model, and
the second ML model is a currently deployed ML model that is currently deployed at the client computing device.

7. The method of claim 2, wherein
the first ML model is one of the local ML model or a specific use-case model,
the second ML model is a currently deployed ML model that is currently deployed at the client computing device, and
the fourth ML model is another one of the local ML model and (i) the specific use-case model.

8. The method of claim 1, wherein
the first ML model is a specific use-case model or a currently deployed ML model that is currently deployed at the client computing device, and
the second ML model is the local ML model.

9. The method of claim 6, the method further comprising:
receiving from a shared storage specific use-case model information identifying the specific use-case model, wherein
the specific use-case model is shared among two or more client computing devices including the client computing device; and
the shared storage is configured to be accessible by said two or more client computing devices.

10. The method of claim 6, wherein the deploying of the second ML model comprises replacing the currently deployed ML model with the second ML model as the model that is currently deployed at the client computing device.

11. The method of claim 1, wherein
the input data set is stored in a local storage element;
the local storage element is included in the client computing device; and
the method further comprises, after deploying the third ML model, removing the input data set from the local storage element.

12. The method of claim 11, wherein
the input data set is removed from the local storage element in response to an occurrence of a triggering condition; and
the occurrence of the triggering condition is any one or a combination of (i) that a predefined time has passed from the timing of storing the input data set at the local storage element, (ii) receiving a removing command signal from the control entity, and (iii) that the amount of storage spaces available at the local storage element is less than a threshold value.

13. The method of claim 6, wherein the specific use-case ML model is associated with any one or a combination of a particular season of a year, a particular time period within a year, a particular public event, and a particular value of the temperature of the area in which the client computing device is located.

14. The method of claim 1, wherein
the client computing device is a base station; and
the third ML model is a ML model for predicting traffic load in a region associated with the base station.

15. A method performed by a client computing device, the method comprising:
deploying a first machine learning (ML) model;
after deploying the first ML model, training a local ML model, thereby generating a trained local ML model;
transmitting to a control entity the trained local ML model;
training the deployed first ML model using the trained local ML model, thereby generating an updated first ML model; and
deploying the updated first ML model.

16-17. (canceled)

18. An apparatus, the apparatus comprising:
a memory; and
processing circuitry coupled to the memory, wherein the apparatus is configured to:
obtain a first machine learning (ML) model, wherein the first ML model is configured to receive input data set and to generate first output data set based on the input data set;
train a second ML model based at least on the input data set and the first output data set;
obtain, as a result of training the second ML model, a third ML model; and
deploy the third ML model.

19. (canceled)

20. An apparatus, the apparatus comprising:
a memory; and
processing circuitry coupled to the memory, wherein the apparatus is configured to:
deploy a first machine learning (ML) model;
after deploying the first ML model, train a local ML model, thereby generating a trained local ML model;
transmit to a control entity the trained local ML model;
train the deployed first ML model using the trained local ML model, thereby generating an updated first ML model; and
deploy the updated first ML model.

21. (canceled)

22. The apparatus of claim 18, wherein
the apparatus is configured to obtain a fourth ML model,
the fourth ML model is configured to receive the input data set and to generate second output data set based on the input data set, and
the training of the second ML model comprises training the second ML model based at least on the input data set, the first output data set, and the second output data set.

23. The apparatus of claim 22, wherein the apparatus is configured to:
calculatean output average or a weighted output average of (i) data included in the first output data set and (ii) data included in the second output data set, wherein
the training of the second ML model comprises:
providing to the second ML model the input data set;
providing to the second ML model the calculated output average or the calculated weighted output average; and
changing one or more parameters of the second ML model based at least on (i) the input data set and (ii) the calculated output average or the calculated weighted output average.

24. The apparatus of claim 23, wherein
calculating the weighted output average comprises:
obtaining a first weight value associated with the data included in the first output data set;
obtaining a second weight value associated with the data included in the second output data set; and
the apparatus is configured to change the first weight value and/or the second weight value based on an occurrence of a triggering condition.
